(19) United States
(12) Patent Application Publication
(10) Pub. No.: US 2005/0230562 A1
(43) Pub. Date: Oct. 20, 2005

(54) Payload fairing separation system

(76) Inventor: David Benjamin Buehler, Provo, UT (US)

Correspondence Address: David Buehler, 893 West 2150 North, Provo, UT, 84604, US

(21) Appl. No.: 10/868,402

(22) Filed: Jun. 14, 2004

Related U.S. Application Data
(63) Continuation of application No. 60/477,536, filed on Jun. 11, 2003.

(51) Int. Cl. B64G 1/52

(52) U.S. Cl. 244/173.1

(57) ABSTRACT

The invention is a payload fairing separation system that is resettable and operates in two stages. The system includes releasable, resettable seam connectors that hold the fairing together in combination with releasable point connectors. At the time of separation, the seam connectors release first, and then the point connectors release. This allows the fairing to separate cleanly at a precise time, without using pyrotechnic charges, and with low shock to the payload.

This application is a continuation of provisional application No. 60/477,536 filed on Jun. 11, 2003, titled “Two-stage, resettable, non-pyrotechnic payload separation system”.

### BACKGROUND OF THE INVENTION

The invention relates to the field of separation systems for orbital launch vehicle payload fairings and the like and, in particular, to a separation system that does not include pyrotechnics.

Description Of Related Art

Payload fairings are used to protect the spacecraft or other payload while it is being transported into orbit on a rocket. Without a fairing, the spacecraft atop the rocket would be subjected to large aerodynamic loads. The fairing blocks the aerodynamic loads, and transmits forces down to the rocket.

Once the rocket has left the atmosphere, the payload fairing is typically jettisoned. It is preferably jettisoned before the rocket reaches orbit, in order to reduce the amount of mass the rocket must launch into orbit. If the payload fairing were carried all the way into orbit, it would decrease the size of the payload which could be carried

Payload fairings thus require a separation system. Because the fairing commonly must separate while the rocket is still under power, it typically has a seam down each side so that it can divide in half longitudinally. Thus the fairing separates into two pieces that fall away to either side and behind the rocket.

Prior systems typically employ explosive charges in various configurations. Some systems use explosively actuated fasteners, such as explosive bolts and the like. Another system involves an explosive charge called a line charge, which is distributed along the fairing seam, and upon activation fractures the coupling that secures the seam. Such a system is disclosed in U.S. Pat. No. 5,443,492 “Payload Housing And Assembly Joint For A Launch Vehicle” by A. L. Chan, et al. One major reason for the use of explosive charges in separation systems is the need to precisely control the timing of separation. Explosives are suited to satisfy this demand because they act quickly once triggered.

However, pyrotechnic fasteners and the like, while well proven in general, can not be individually tested prior to use, since they are destroyed upon activation. Hence they must be assembled with great care to assure reliability. This makes them generally expensive to manufacture. Further, special storage areas must be set aside for any device containing explosives. They are always subject to inadvertent actuation, and, therefore, handled with great care. They are particularly subject to ignition by electromagnetic interference (EMI) and thus must be protected by EMI shielding devices, which also raises the cost. Another disadvantage is that, due to the fact that the explosive charge can be ignited by exposure to high temperature, they have a limited environmental temperature range. One of the most important disadvantages is that upon actuation, most generate significant shock loads, which can damage nearby equipment and make spacecraft design more expensive.

Thus in order to eliminate the above disadvantages non-pyrotechnic designs have emerged. For example, U.S. Pat. No. 5,046,426 “Sequential Structural Separation System” by G. J. Julien, et al. uses a sequence of wires or foil strips attached by their ends to the edges of adjoining segments, thus securing them together. But when heated the wires or foils melt, allowing the segments to separate. By varying the lengths of the wires or foils in sequence, they can be made to fuse in sequence. One disadvantage of this system is that every wire or foil must be separately connected to an electrical circuit. This adds complexity. Further, as with pyrotechnic fasteners, testing of this system is destructive, and resetting after testing requires substantial part replacement. As a result, it is not possible to test the system as it will be flown; rather, the system that flies always includes untested parts.

Another system uses a cable alternately wound around pulleys mounted on opposing sections of the fairing, which when severed releases the fairing section with low shock. This system is disclosed in U.S. Pat. No. 6,439,122 “Separation System for Missile Payload Fairings”, by Nygren et al. However, under one embodiment the system employs explosive charges to sever the cable, thus incurring the heightened handling and storage costs of explosive materials. Another embodiment employs a cable composed of a material with a low melting temperature, and thus avoids using explosives, but is limited in its use to applications in which environmental temperatures remain low. A further difficulty with either embodiment of this design is the need to control the untethered cable, or fragment of cable, once it is severed, to assure that it neither interferes with the separation process nor damages nearby equipment as it recoils from its loaded state. A system whose behavior can be more precisely predicted and controlled would be desirable. Moreover, the cable-pulley system, like pyrotechnic systems, does not allow non-destructive testing, and so cannot be tested exactly as it will be flown.

These existing systems that reduce or avoid the use of pyrotechnics may allow for simpler storage and reduce the shock loads introduced into the fairing structure upon release. Yet they still cannot be tested as they will fly, but can only be built carefully, and they are not resettable without substantial refurbishment. They also are subject to the design constraint of having to release very quickly, so that proper timing of separation within the flight plan can be achieved. This design constraint further adds to expense.

The Problem

The problem is that payload fairings typically use explosives, or other non-resettable systems, to achieve fairing separation. This makes it more expensive to manufacture, more difficult to ensure reliability, and more demanding to store and prepare the rocket to be launched. It also may introduce shock to the spacecraft when the fairing separates.

The Response

What is needed is a payload fairing separation system that is resettable, holds the fairing together in a secure and robust fashion until the time for separation, and then causes timely and clean separation without explosives and with low shock. This would reduce operational costs and storage and preparation costs on the rocket. It can also improve reliability, because operation can be tested. It would thus reduce the expense of putting payload into orbit.

A resettable, non-pyrotechnic separation system would also improve the responsiveness of a launch system, since it would be easier to prepare, store, and transport. In particular, it would have the advantage that it would be easier to integrate payload early, at the payload owner's facility, and transport the integrated fairing and payload. This is because there would be no explosives in the fairing, and so it can be easily transported ready for deployment. Yet because the system is resettable, if it became necessary to service, reconfigure or replace the payload, the fairing could be disassembled easily by activating the separation system, and then reassembled, resetting the separation system. In general, the planning of launch preparations will be simpler when the fairing separation system is resettable.

Thus in sum, a primary object of the invention is to provide a system for securing the segments of a structure together and to provide for timely and reliable separation of the segments.

Further objects of the invention are to provide such a system, which:
does not include pyrotechnics;
can be repeatedly tested to verify reliability without requiring remanufacture;
is easily stored and transported in a state of readiness for deployment;
is easily activated and reset to accommodate reconfiguration, maintenance, or replacement of payload items;
provides for separation of the segments without significant shock loads being introduced into the structure;
distributes much of the load during flight through the atmosphere to securing mechanisms that need not release instantaneously for separation, namely, the seam connectors; and
because of the above points, is less expensive to manufacture and operate than several alternatives.

### BRIEF SUMMARY OF INVENTION

The invention consists of a two-stage, non-pyrotechnic separation system for a launch vehicle payload fairing.

The fairing itself is split lengthwise, so it divides into pieces which fall away from the vehicle. The seam where it splits is held together during flight by seam connectors. The fairing sections are also held together by at least one point connection device. The point connector holds the fairing together while the interlock is in the process of disengaging, and while it is disengaged.

During the time the vehicle is traveling through the atmosphere, the payload fairing is used to shield the payload from aerodynamic forces. Once the vehicle has left the atmosphere, the payload fairing may be jettisoned to minimize the extra mass the vehicle is carrying.

By using a combination of point connection devices and seam connectors, the seam connectors can be built so that they do not have to release instantaneously. For example, the disengagement mechanism for the seam connectors could consist of a motor driving a gear reduction system. With proper gearing, such a disengagement mechanism can insert a significant amount of force on the interlock, with only a modest continuous power input.

The seam connectors can be constructed in multiple sections to accommodate various fairing geometries. One section might run up the side of a cylindrical portion of the payload fairing, to the point where the cylindrical section meets a conical portion. A separate seam connector would run along the straight side of the conical portion. Force to cause disengagement could be transmitted from one interlock to another by a flexible linkage running in a track. Or, two actuators could be employed, one for each section of the seam connector.

In the main embodiment, a single actuator is utilized for the two pairs of seam connector. The actuating force is transmitted from one member of a pair to another by a flexible chain constrained in a track. Thus the two connectors comprising a pair are actuated simultaneously but in series, while the two pairs of connectors are actuated in parallel. A single point connector is employed to hold the top of the payload fairing together while the actuators are disengaging the interlock devices.

In the main embodiment, springs or comparable mechanisms are placed so as to push the fairing halves apart upon release of the connectors. The nose of the fairing separates first, followed by the tail. Once the nose ends are safely clear of the payload, the tail is released, and the fairing falls away.

This separation system has several advantages. It can be transported easily. It is less expensive to work with because it has no explosives. The mechanism can be tested repeatedly, and the same mechanism flies. This should improve reliability. It can be activated to easily disassemble the fairing, and then easily reset. It can also be sealed at the customer's site and filled with inert gas, then transported to the launch facility and launched. This reduces operation costs by not requiring a clean room at the launch facility. It also has the advantage that it releases gently, with no high shock loads to the payload.

### BRIEF DESCRIPTION OF THE DRAWINGS

FIG. 1 is a perspective view of the launch sequence of a booster rocket for placing a payload in orbit.

FIGS. 2A to 2C are a series of enlarged views of a portion of FIG. 1, illustrating separation of the fairing from the upper stage.

FIG. 3 is a side view of one half of the fairing shown in FIGS. 1 and 2, showing an arrangement of seam connectors and point connectors.

FIG. 4 is an enlarged view of a portion of FIG. 2 illustrating the interlock embodiment of the seam connectors, in the disengaged position.

FIG. 5 is an enlarged view of a portion of FIG. 2 illustrating the interlock embodiment of the seam connectors, in the engaged position.

FIGS. 6A and 6B are schematic views similar to FIG. 3, illustrating variant dispositions of point connectors.

FIGS. 7A to 7C are schematic views similar to FIG. 3, illustrating variant dispositions of actuators for the releasable seam connectors.

FIG. 8 is a cross-sectional top view of the fairing as mounted to a rocket stage, showing a releasable circumferential attachment mechanism, with mechanism to effect release.

### DETAILED DESCRIPTION

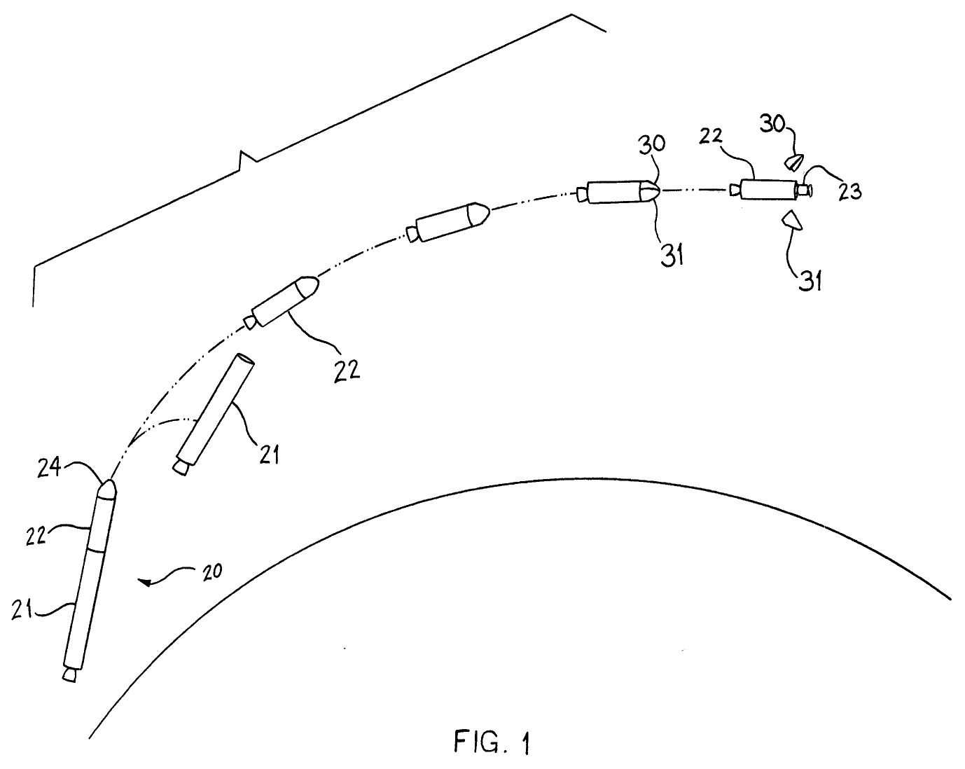

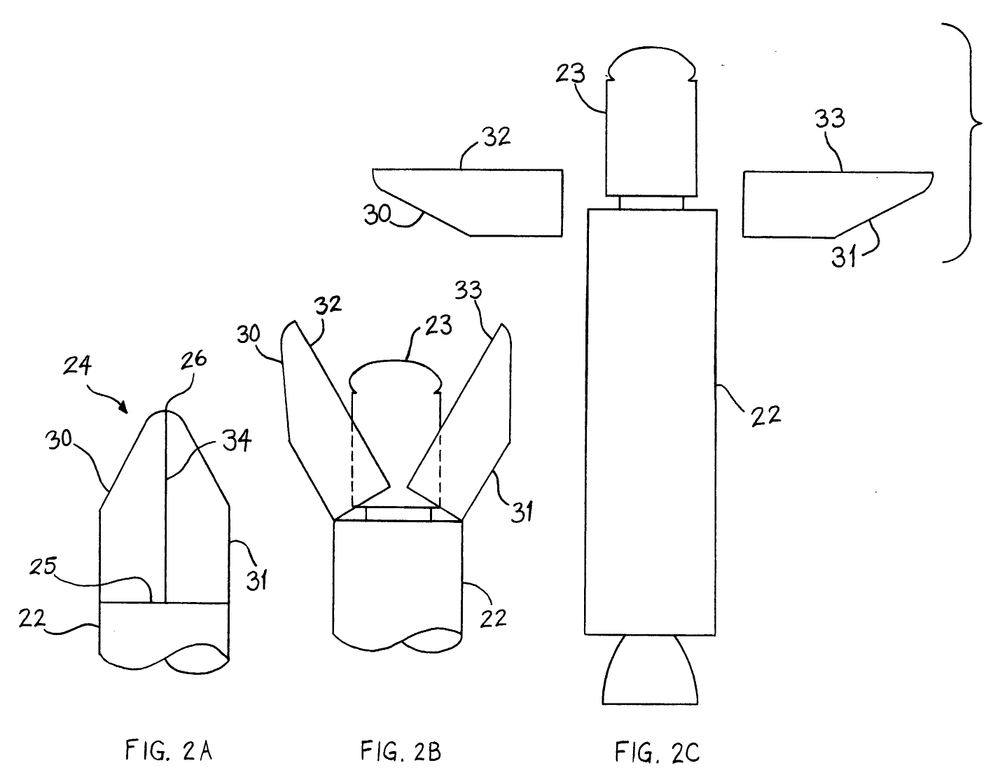

Referring to FIGS. 1-2, the typical launch vehicle, generally indicated by numeral 20, includes a lower stage 21 and upper stage 22 upon which is mounted a payload 23 covered by a fairing assembly 24. The fairing assembly 24 is generally cone shaped having a base portion 25 and a nose end 26. Typically two or more stages are necessary to place a satellite in orbit.

Referring to FIG. 2A to 2C, the fairing comprises two fairing halves 30 and 31 having mating edges 32 and 33 that meet to form a seam 34.

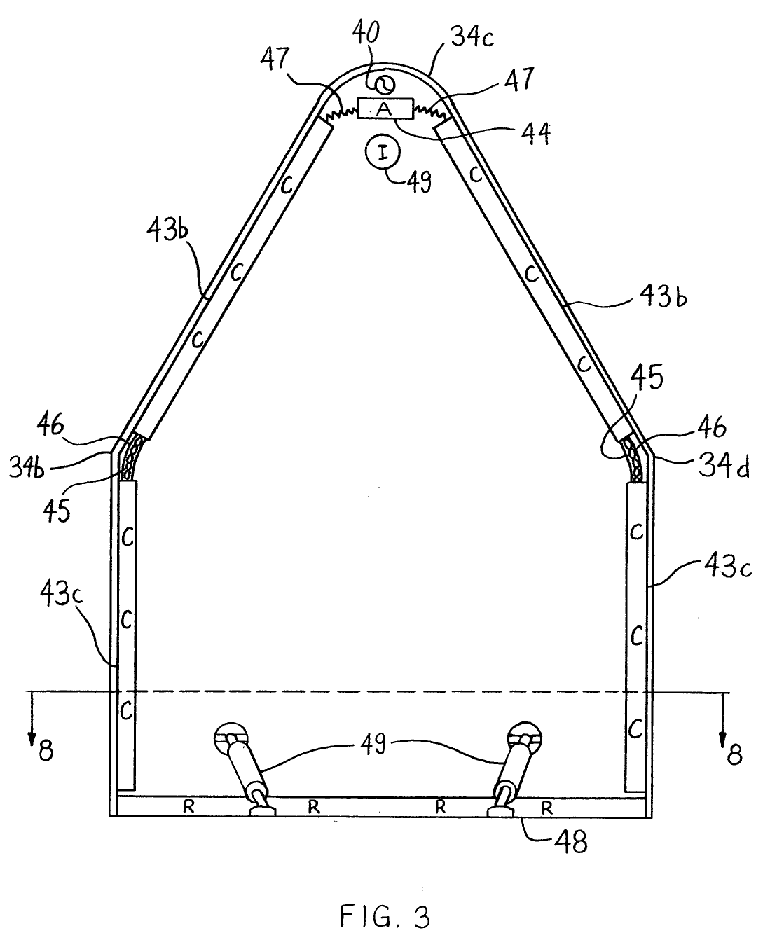

Referring to FIG. 3, at the nose 26 the mating edges of the fairing halves 30 and 31 are articulated so as to be joinable by a releasable point connector 40, represented in FIGS. 3 and 6A to 7C by a circle inscribed with an S-curve. The releasable point connector 40 also may take a variety of forms, including the Starsys FASSN. Mounted on the interior surfaces 41 and 42 of the fairing halves 30 and 31 are a plurality of resettable, releasable seam connectors 43, each represented in FIGS. 3 and 6A to 7C by a rectangle inscribed with letters “C”. In regard to this invention, a connector will be resettable if it can be activated so as to disengage, and then reengaged without requiring substantial refurbishment. The number of seam connectors will vary depending upon the geometry and size of the fairing assembly 24. In the main embodiment, each straight portion of the seam in the fairing assembly is held together by a distinct seam connector. The fairing is reinforced in the vicinity of curved or angled portions of the seam 34b to 34d, to add stiffness so that the mating edges remain tightly joined between connectors. The base end 25 of the fairing is secured to the upper stage 22 of the launch vehicle 20 by a releasable, circumferential attachment mechanism 48, represented in FIG. 3 by a rectangle inscribed with letters “R”. The releasable circumferential attachment mechanism 48 may take a variety of forms, such as the clamping band disclosed in U.S. Pat. No. 4,715,565. Springs or other mechanisms 49 for pushing the fairing halves away from the upper stage and payload are mounted on the inside of the fairing so as to press against the upper stage, or simply to press against the two halves of the fairing. In FIG. 3, one spring or similar mechanism 49 mounted near the nose end of the fairing half is represented by a circle inscribed with a letter “I”. In either case, the springs or similar mechanisms 49 are attached to one or more section of the fairing so as to fall away with the fairing at separation, again minimizing the mass the vehicle must carry into orbit.

Referring again to FIG. 3, the separation system in the main embodiment employs a single point connector 40 at the nose end of the fairing 26. Further, a single actuator 44 is configured to cause all four seam connectors to disengage. The actuator causes the seam connectors to disengage by moving them from the engaged position to the disengaged position. Actuating force is transmitted from the actuator to at least one seam connector by a transmission mechanism 47 which in the main embodiment comprises a gear reduction system. In the main embodiment, actuating force is transmitted directly from the actuator, in parallel fashion, to two seam connectors 43b mounted inside the conical section of the fairing. It is then further transmitted from each of the seam connectors 43b, to one of the seam connectors 43c mounted inside the cylindrical section of the fairing, by means of a flexible linkage 45 constrained in a track 46.

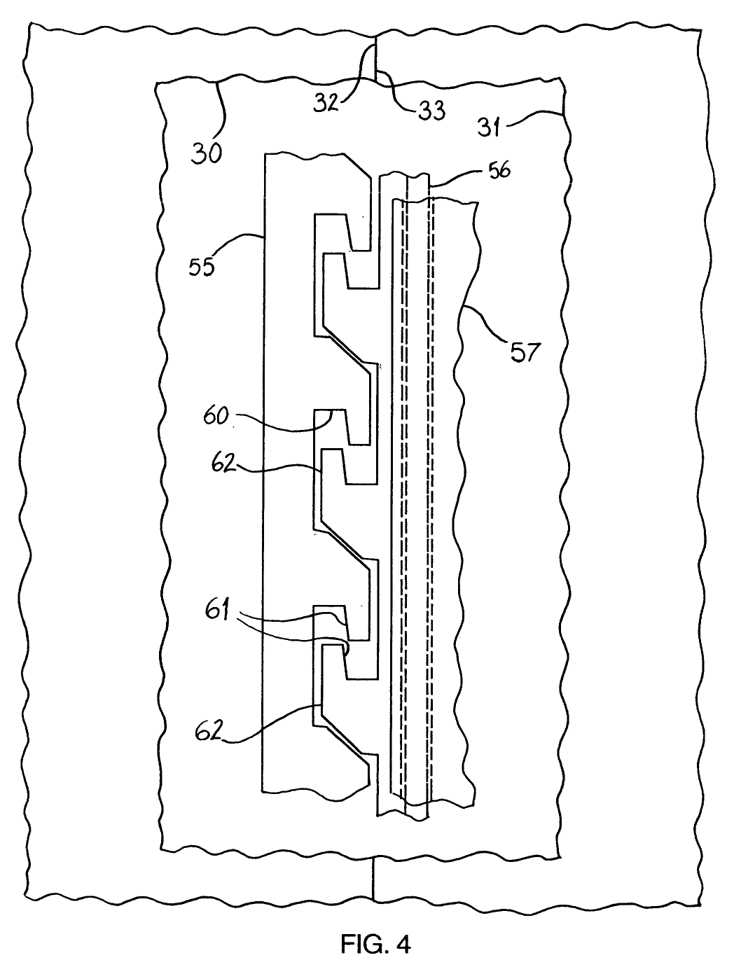

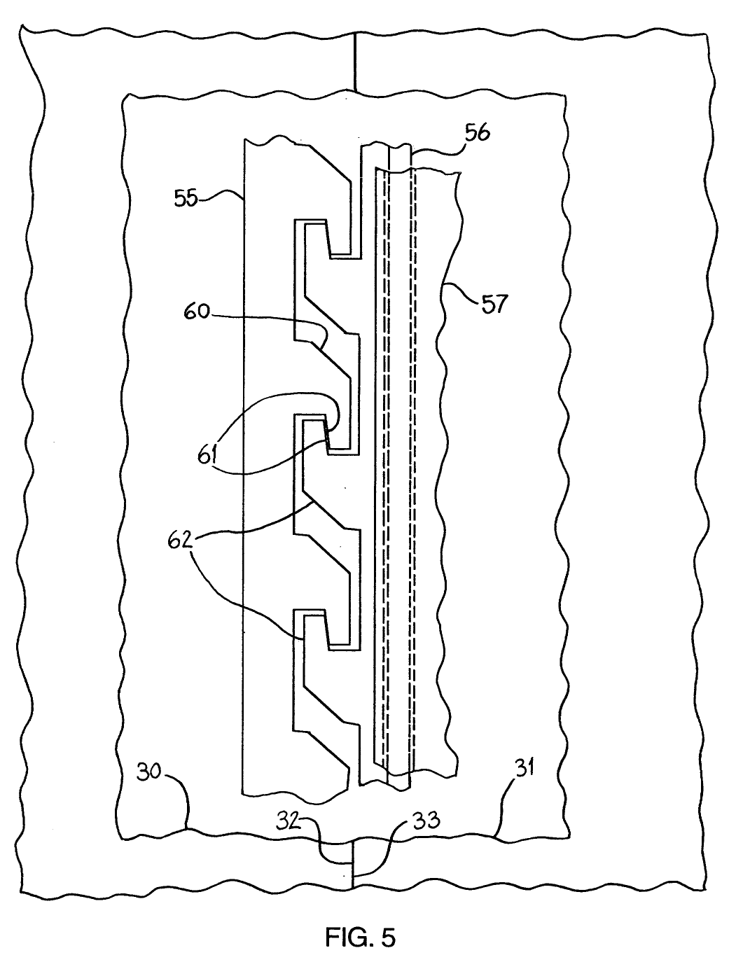

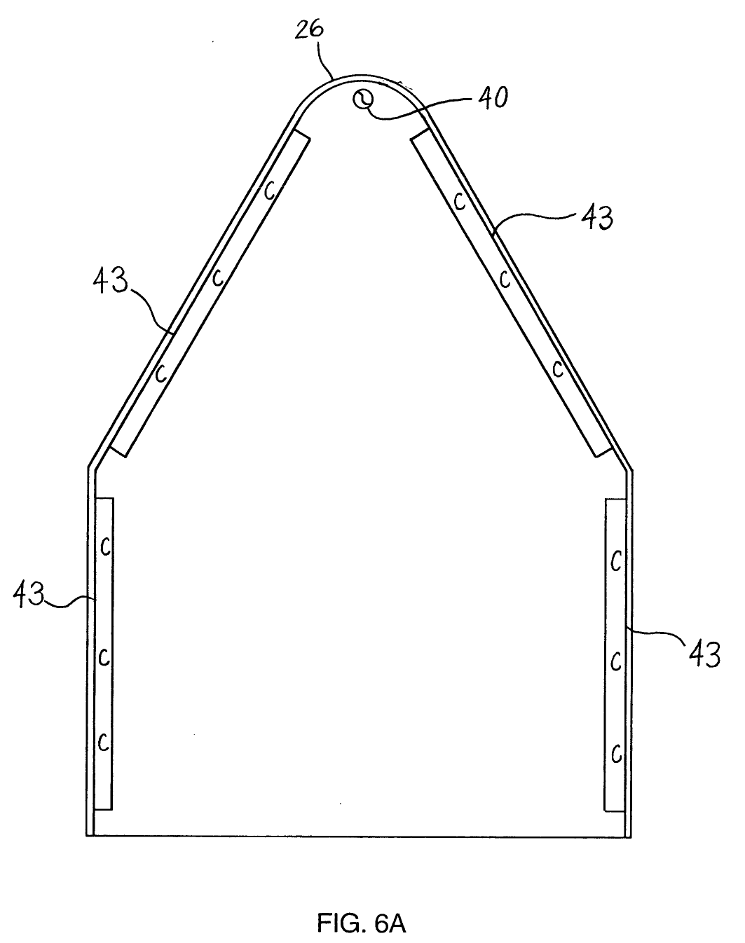

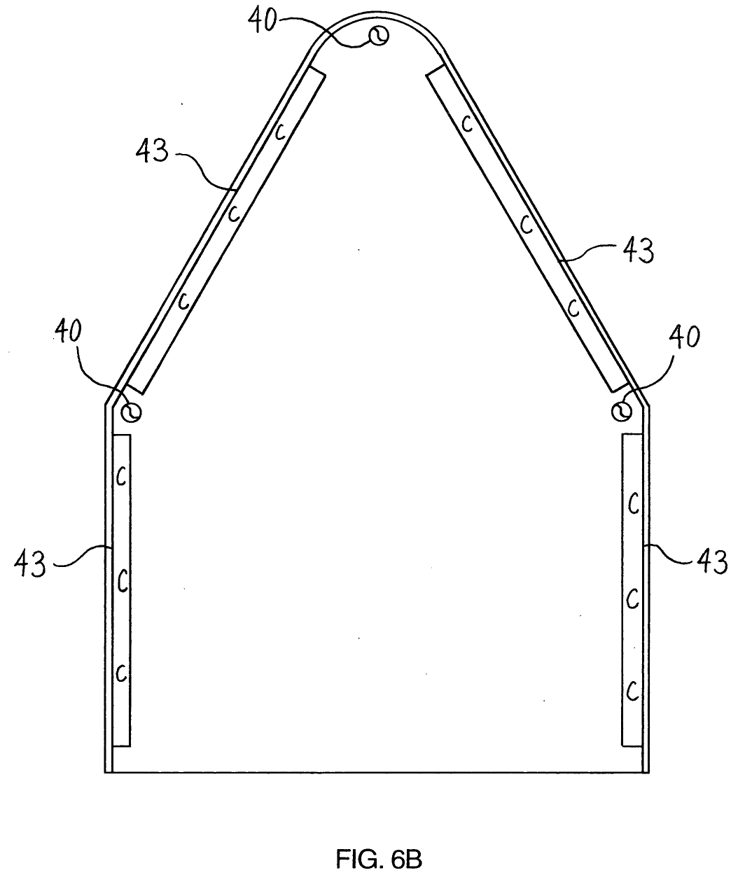

Referring to FIGS. 4 and 5, in the main embodiment each seam connector comprises a pair of interlock members: a fixed interlock member 55 attached to one half of the fairing 30 and a sliding interlock member 56 constrained in a race 57 attached to the other half of the fairing 31. One interlock member bears a set of shaped teeth 60, and the other bears a corresponding set of tooth receptors 62. In the main embodiment the teeth are similar in shape to the tooth receptors, and the teeth 60 and tooth receptors 62 are shaped so as to be slidably engageable with each other. As depicted in FIG. 6, in the main embodiment each tooth or tooth receptor bears a beveled surface 61. These beveled surfaces 61 of opposing teeth and tooth receptors engage with each other so that as the sliding interlock member 56 moves into the fully engaged position, the connector as a whole is preloaded. This preloading improves the security of the joint formed by the interlock pair, which must withstand high loading and vibration during flight through the atmosphere.

Referring to FIG. 6, a variety of configurations of point connectors 40 are possible. In some embodiments at least one point connector 40 will be placed at the nose end of the fairing 26, as in FIG. 6A. Specifics of the geometry of a particular fairing assembly, the character of its load-bearing structure, and its means of attachment to the upper stage of the rocket may render it advantageous to employ point connectors 40 elsewhere, as in FIGS. 6B and 6C.

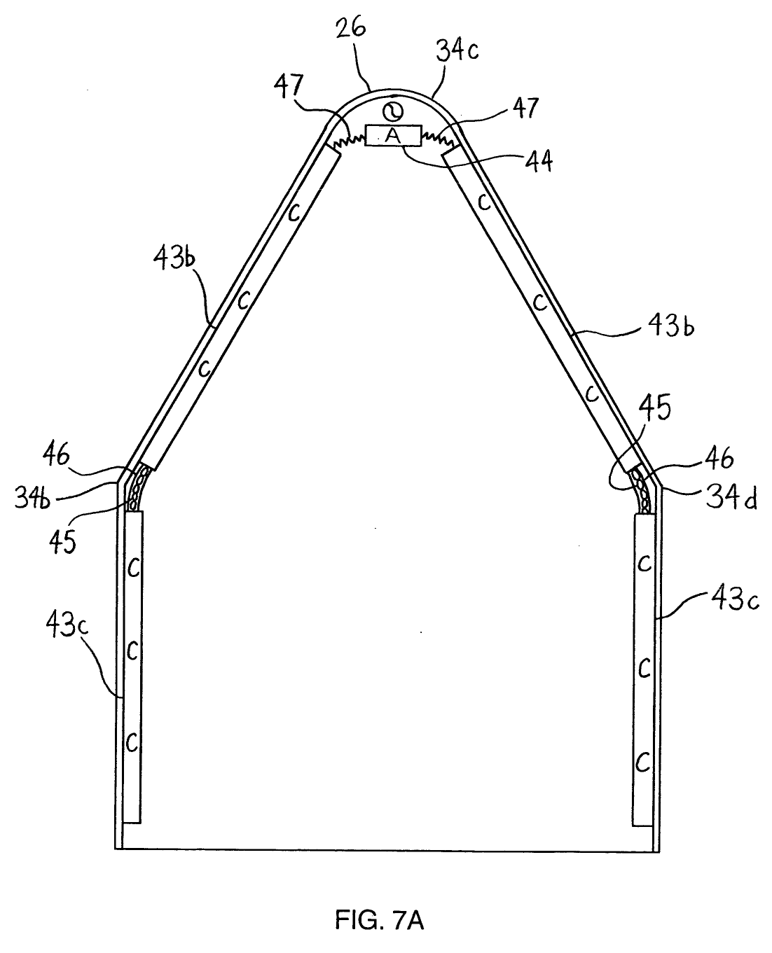

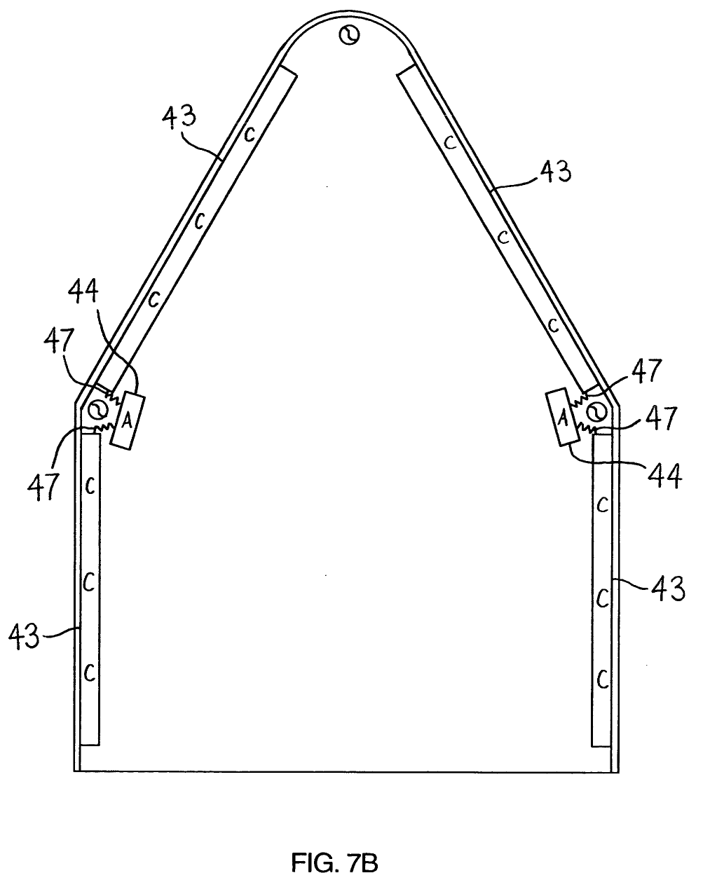

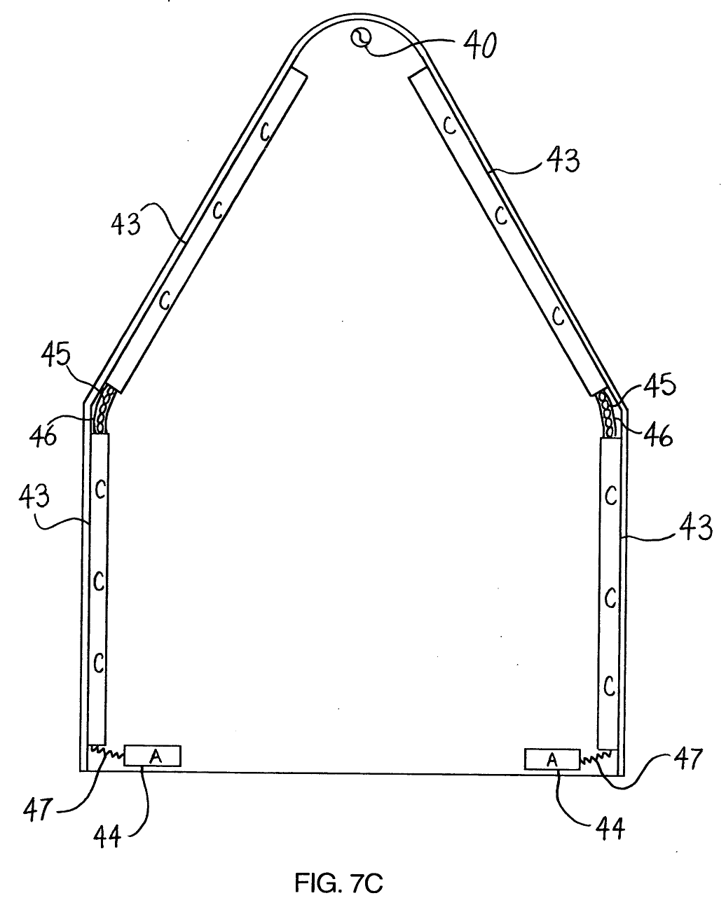

Referring to FIG. 7, a variety of configurations of actuators 44 are possible. In some cases it may be advantageous to configure actuators 44 to act directly on each seam connector 43, without transmitting actuating force from one connector to another. In such cases, it may be advantageous to place actuators between pairs of seam connectors 43, at locations other than the nose end, as in FIG. 7B. The best placement of actuators 44 for a given embodiment may depend on the type of actuator employed, whether it pushes, pulls, or applies torque to the seam connector, and other such details of the embodiment. In some embodiments it will be preferable that the actuators be mounted on sections of the fairing so that they fall away with it once their purpose is fulfilled, to minimize the mass that the rocket must carry into orbit.

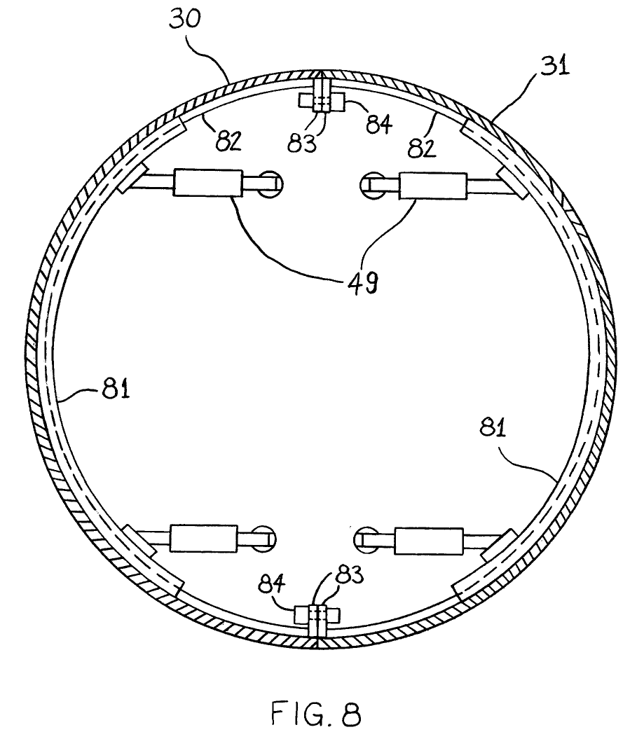

Referring to FIG. 8, one embodiment of a releasable, circumferential attachment mechanism for securing the fairing to the upper stage of the rocket is a flange-groove mechanism. The leading end of the upper stage bears two grooves 81, running substantially around the circumference of the upper stage. The interior base portions of the fairing halves 30 and 31 bear a pair of flanges 82 running substantially around the circumference of the fairing assembly. While the fairing is assembled, the mating grooves and flanges 81 and 82 are kept engaged by a pair of releasable point connectors 84, regarded as parts of the releasable, circumferential attachment mechanism. These releasable point connectors 84 join the fairing halves near the base portion and are preloaded so as to apply a tension load around the circumference of the fairing. This tension load keeps the grooves 81 and flanges 82 securely engaged with each other. To reduce the travel required for disengagement of the flanges 82, the grooves 81 do not run along the entire circumference of the upper stage.

When used with this releasable, circumferential attachment mechanism, the springs or similar mechanisms 49 for urging the fairing halves apart are positioned so as to initially push the fairing halves substantially outward from the axis of the vehicle. Thus the springs or similar mechanisms 49 push the flanges 82 free of the grooves 81 near the beginning of their travel.

It is important to assure that the fairing halves do not collide with the payload during or after separation. Hence in the main embodiment, the releasable, circumferential attachment mechanism includes a mechanism to assure that the base portions of the fairing halves do not fully detach from the launch vehicle before the leading portions of the fairing halves have tipped clear of the flight path of the payload. This mechanism includes a retainer or retainers mounted at the base of each fairing half, and retainer receptors mounted near the leading end of the upper rocket stage. These retainers are configured to engage with the retainer receptors, keeping the fairing halves connected to the upper rocket stage even as the fairing halves separate from each other. As the fairing halves move apart, under the influence of the springs or similar mechanisms 49, the nose ends of the fairing halves rotate outward, away from the axis of the launch vehicle, as depicted in FIG. 2B. The base portions of the fairing halves, however, remain connected to the upper stage by means of the retainers until the nose ends have moved clear of the flight path of the payload. The retainers and retainer receptors are configured to first allow the base portions of the fairing halves to slide outward to a distance that precludes binding of flanges 82 in grooves 81. The retainers and retainer receptors are further configured to retain the fairing halves just until they reach a certain degree of rotation outward from the axis of the vehicle. Thus when the fairing halves reach this degree of rotation, the base portions of the fairing halves disconnect from the upper stage and are pushed free by the springs or similar mechanisms 49, as depicted in FIG. 2C

Operation

During takeoff and until the launch vehicle 20 has substantially left the atmosphere, extremely high loads are introduced into the fairing assembly 24, which are produced by aerodynamic forces as the launch vehicle accelerates through the atmosphere, as well as those induced by vibration loads produced by the propulsion system. The fairing assembly protects the payload 23 from aerodynamic loads during flight through the atmosphere, but then is jettisoned once the vehicle has left the atmosphere.

Referring to FIGS. 1 and 3, while the fairing assembly is under high loads, the halves of the fairing 30 and 31 are secured together by the combination of seam connectors 43 and point connector 40. In the main embodiment, the seam connectors comprise a pair of interlock members which disengage slowly, and the point connector is a Starsys FASSN. Thus the seam connector is a slow-releasing connector, and the point connector is a quick-releasing connector. The fairing halves are also attached to the upper stage of the rocket 22 via the circumferential attachment mechanism 48. Once the launch vehicle has left the denser portions of the atmosphere, the loads in the fairing assembly are greatly reduced. At some point in the flight, the loads in the fairing assembly drop to a level such that the point connector 40, in combination with the circumferential attachment mechanism 48, suffices to secure the halves of the fairing together. At this point the slow-releasing connectors, the seam connectors 43, may begin disengaging. Thus the disengagement process may begin substantially before the time for separation of the payload fairing. In the main embodiment, the disengagement of slow-releasing seam connectors is triggered by a control system significantly before the time for fairing separation. Then precise timing of fairing separation is achieved by activating the quick-releasing point connectors as the slow-releasing connectors reach full disengagement, or thereafter. In response to disengagement of the quick-releasing point connectors, one or more springs or similar mechanisms 49 push the fairing halves apart and away from the payload and rocket. The appropriate timing for disengagement of the circumferential attachment mechanism 48 will depend on the nature of that mechanism and the manner in which it disengages. In the case of the flange-groove mechanism described above, its disengagement may be triggered by disengaging the releasable point connectors it includes, at the same time as the releasable point connectors used elsewhere in the fairing assembly.

While the invention has been described in the specification and illustrated in the drawings with reference to a main embodiment and certain variations, it will be understood that these embodimenst are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

1. An apparatus for protecting and uncovering a payload, the apparatus comprising:
a plurality of fairing sections;
at least one resettable seam connector, configured to releasably hold fairing sections together;
at least one point connector configured to releasably hold fairing sections together.

2. The apparatus of claim 1, wherein the at least one point connector is configured to disengage after disengagement of the at least one resettable seam connector.

3. The apparatus of claim 1, wherein the at least one point connector is resettable.

4. The apparatus of claim 1, wherein the at least one resettable seam connector is configured to be disengaged by an actuator.

5. The apparatus of claim 4, wherein the actuator is selected from the group consisting of an electric motor, a gas piston, and a spring loaded puller restrained by a separator.

7. The apparatus of claim 1, further comprising a flexible linkage configured to transmit actuation from a first seam connector to a second seam connector.

8. The apparatus of claim 1, further comprising a first actuator configured to disengage a first seam connector and a second actuator configured to disengage a second seam connector.

9. The apparatus of claim 1, wherein the at least one resettable seam connector comprises a first interlock member connected to a first fairing section and a second interlock member connected to a second fairing section.

10. The apparatus of claim 9, wherein the first interlock member comprises a set of teeth.

11. The apparatus of claim 10, wherein the second interlock member comprises a set of tooth receptors.

12. The apparatus of claim 1, further comprising a biasing means for urging fairing sections apart in response to disengagement of the at least one resettable seam connector.

13. The apparatus of claim 12, wherein the biasing means comprises at least one spring.

14. The apparatus of claim 1, wherein the plurality of fairing sections are configured to form a rocket fairing.

15. The apparatus of claim 14, wherein the rocket fairing is secured to a leading portion of a rocket stage by a releasable, circumferential attachment mechanism.

16. The apparatus of claim 15, wherein the releasable, circumferential attachment mechanism comprises:
fairing sections articulated near the base portion of the fairing so as to be joinable by at least one releasable point connector disposed near the base portion of the fairing;
at least one groove on the leading portion of the rocket stage and lying near the circumference of the rocket stage;
at least one flange mounted on a base portion of a fairing section and configured so that while the fairing is assembled, the at least one flange fits into the at least one groove.

17. A method for protecting and uncovering a payload, the method comprising:
releasably holding a plurality of fairing sections together with at least one resettable seam connector and at least one point connector; and
releasing the fairing sections.

18. The method of claim 17, wherein releasing the fairing sections comprises disengaging the at least one point connector after disengaging the at least one resettable seam connector.

19. An apparatus for protecting and releasing a payload, the apparatus comprising:
a plurality of fairing sections;
at least one slow-releasing connector configured to releasably hold fairing sections together in a resettable, non-destructive manner; and
at least one quick-releasing connector configured to releasably hold fairing sections together.

20. The apparatus of claim 19, wherein the at least one quick-releasing connector is configured to disengage after disengagement of the at least one slow-disengaging connector.

21. The apparatus of claim 19, wherein the at least one point connector is resettable.

22. The apparatus of claim 19, wherein the at least one slow-releasing connector comprises a first interlock member connected to a first fairing section and a second interlock member connected to a second fairing section.

23. The apparatus of claim 22, wherein the first interlock member comprises a set of teeth.

24. The apparatus of claim 22, wherein the second interlock member comprises a set of tooth receptors.

25. The apparatus of claim 19, wherein the rocket fairing is secured to a leading portion of a rocket stage by a releasable, circumferential attachment mechanism.
